(19) United States
(12) Patent Application Publication
(10) Pub. No.: US 2017/0097040 A1
(43) Pub. Date: Apr. 6, 2017

(54) CHASSIS BEARING

(71) Applicant: BENTELER AUTOMOBILTECHNIK GMBH, Paderborn (DE)

(72) Inventor: Eric SCHULTZ, Paderborn (DE)

(73) Assignee: BENTELER AUTOMOBILTECHNIK GMBH, Paderborn (DE)

(21) Appl. No.: 15/282,041

(22) Filed: Sep. 30, 2016

(30) Foreign Application Priority Data
Oct. 2, 2015 (DE) 10 2015 116 799.9

(51) Int. Cl. F16C 27/06; F16C 33/22; F16C 17/10

(52) U.S. Cl. CPC F16C 27/063; F16C 17/10; F16C 33/22; F16C 2326/05

(57) ABSTRACT

The present invention relates to a solid rubber bearing for arranging on an axle of a motor vehicle, the solid rubber bearing comprising an inner sleeve and an outer sleeve, with an elastic intermediate layer being arranged between the inner sleeve and the outer sleeve; on one side the inner sleeve has a stop disc that extends radially outwards from the inner sleeve, with the outer sleeve extending in the axial direction A over a portion of the inner sleeve; and with a space being formed between the outer sleeve and the stop disc, the solid rubber bearing being characterized in that at least one spacer made of a solid material is arranged in the region of the space.

### FIELD OF THE INVENTION

The present invention relates to a solid rubber bearing on a motor vehicle axle in accordance with the features disclosed in the preamble of patent claim 1.

It is known from the prior art to fasten chassis components to motor vehicles. In modem motor vehicles, multilink axles or torsion beam axles for coupling are connected to the self-supporting chassis. In this case, the axle components are fastened to the chassis or to an auxiliary frame. In order to enable not only the kinematic coupling of the frame to the chassis component, not only strictly pivot bearings, but also elastokinematic bearings are used. At the same time these bearings make it possible to reduce or, more specifically, to damp the vibrations and/or noises that are generated when the vehicle is in driving mode.

Such bearings are also called rubber-to-metal bearings or solid rubber bearings. They are usually characterized by the feature that an inner sleeve and an outer sleeve are coupled to each other with the incorporation of an elastic material that is located in-between. Then the inner sleeve and the outer sleeve enable a rotational motion, for example, around a bolt. The elastic material makes it possible to damp vibrations and/or noises and to some extent also rotation due to elastic deformation.

Such a bearing is known for example, from the German patent DE 10 2009 040 163 A1.

### SUMMARY OF THE INVENTION

The object of the present invention is to increase the axial rigidity in a solid rubber bearing.

The aforementioned object is achieved, according to the present invention, by means of a solid rubber bearing for arranging on a motor vehicle axle in accordance with the features disclosed in patent claim 1.

Advantageous variants of the embodiment of the present invention are the subject matter of the dependent patent claims.

The solid rubber bearing for arranging on an axle of a motor vehicle comprises an inner sleeve and an outer sleeve, with an elastic intermediate layer being arranged between the inner sleeve and the outer sleeve. On one side the inner sleeve, in the axial direction, a stop disc that extends radially outwards from the inner sleeve is located. The outer sleeve extends in the axial direction only over a portion of the inner sleeve and, thus, has a shorter axial length than the inner sleeve. The net result is that between the outer sleeve and the stop disc there is a space in the axial direction. On the opposite end of the stop disc the ends of the inner sleeve and the outer sleeve are preferably arranged at the same height in the axial direction. It is provided in accordance with the invention that a spacer made of a solid material is arranged in the region of the space, i.e., between the stop disc and the end of the outer sleeve.

This spacer that is made of a solid material is made preferably of a synthetic plastic material or, instead, of a metallic material. This feature reduces the existing elastic volume of the intermediate layer, so that the axial rigidity is increased. Since the spacer is not arranged between the inner sleeve and the outer sleeve, the radial rigidity increases insignificantly in comparison to the axial rigidity. As a result, the ratio of axial rigidity to radial rigidity can be increased and is preferably greater than 1.5:1, in particular, greater than 2:1 and preferably greater than or equal to 2.5:1. In the latter case, this means that the solid rubber bearing of the invention can achieve an axial rigidity that is 2.5 times greater than the radial rigidity. With respect to the axial direction, a region with an elastic intermediate layer remains preferably between the outer sleeve and the spacer and between the stop disc and the spacer respectively, so that a rigid coupling is not achieved in the axial direction. In particular, the axial rigidity increases in a progressively increasing manner, whereas the radial rigidity increases in a linearly increasing manner. The introduction of the solid intermediate layer significantly increases the axial rigidity as compared to the radial rigidity.

The intermediate layer itself is made of an elastic material, in particular, a rubber-like material or an elastomeric material. Preferably the intermediate layer is coupled by material bonding, in particular, by gluing or vulcanizing, to the inner sleeve and/or the outer sleeve and/or the stop disc. Similarly, the intermediate layer is coupled preferably by material bonding to the spacer.

In a preferred variant of the embodiment, the spacer itself is formed in the manner of a circumferential disc and extends in the axial direction of the solid rubber bearing having the thickness of the disc. However, within the scope of the invention, it is also possible for the spacer to be formed piece by piece in the form of, for example, two quarter discs or also three third discs. As a result, the spacer is not designed completely in a radially circumferential manner, but rather in each case is designed circumferentially only about one segment in the radial direction.

In an advantageous further development, it is also possible to arrange a plurality of spacers, in particular, a plurality of discs, parallel to each other at a distance from each other in the axial direction of the solid rubber bearing. Then, for example, two spacers in the form of two discs can be spaced apart parallel to each other in the axial direction.

Furthermore, it is particularly preferred that the spacer and an outer shell surface of the inner sleeve be designed in such a way that they are spaced apart from each other. Thus, the intermediate layer is also arranged in this space that is set apart.

In another preferred variant of the embodiment, it is possible for the inner contour in the inner cross section of the inner sleeve to be designed circular, but it can also be designed, for example, as a polygon or, instead, also in the manner of a flower. Then these shapes form preferably a cylindrical receiving surface on their ends that are formed inwards. As a result, a bolt, which extends through the inner sleeve, can be rotatably coupled to this receiving surface, but significant weight reductions can be carried out.

It is particularly preferred that the elastic intermediate layer extends in the radial direction with respect to the inner shell surface of the outer sleeve in the region of the space between the outer sleeve and the stop disc.

Furthermore, it is particularly preferred that the outer sleeve can have a collar that is oriented radially outwards, so that the collar and the stop disc extend preferably parallel to each other and have, in particular, the same radius. Preferably the intermediate layer and, in particular, the spacer are arranged between the collar and the stop disc. In this way, a force in the axial direction is transmitted from the collar over the spacer to the stop disc with simultaneously an elastic deformation of the intermediate layer, located between the collar and the stop disc, and is distributed over a larger area. This feature extends the life expectancy. At the same time the axial rigidity is increased.

The stop disc itself can be made in one piece and in a materially uniform manner with the inner sleeve. However, the stop disc can be coupled, as an external component, to the inner sleeve, in particular, to an outer shell surface of the inner sleeve.

Positive locking elements, for example, a protruding nose, can be formed externally preferably on the stop disc and/or on the collar. This feature makes it possible to secure the position of the bearing in a torsion-proof and positive locking manner in the installed state, and/or this feature provides an orientation aid when aligning the bearing.

The intermediate layer can have preferably a cavity that extends circumferentially at least in sections in the axial direction and at least partially in the radial direction. The net result is a progressive radial rigidity. At first, any cavity deforms with almost no resistance. At the same time, then the resulting increasing deformation of the intermediate layer and/or a compression of the rest of the remaining parts of the intermediate layer leads to a progressive radial rigidity.

It is particularly preferred that the outer sleeve can have a cavity that extends circumferentially at least in sections in the axial direction and at least partially in the radial direction. The feature makes it possible to provide the outer sleeve with a large outside diameter while at the same time the weight of the outer sleeve is extremely low.

The inner sleeve and the outer sleeve are made preferably of metallic material.

Furthermore, the present invention relates to an axle assembly, in particular, a torsion beam axle assembly, in which solid rubber bearings of the invention are used as the chassis bearings. Then, in particular, in the case of a torsion beam axle the axle assembly exhibits two solid rubber bearings that may be found, as the chassis bearings, in the region of a left and a right side of the motor vehicle. The axial direction of the solid rubber chassis bearings is oriented preferably in the transverse direction of the motor vehicle. Up and down movement, respectively a pivot movement of the torsion beam axle, always takes place preferably about the axial direction of the solid rubber bearing.

The axle of the inventive axle assembly has an additional toe correcting mechanism. For this purpose, the wheel carrier is preferably mounted in such a way that it can be pivoted about a virtual steering axis, also called the spread axis, so that, in particular, when cornering and/or braking, a mechanism that makes a toe correction based on the driving style is carried out by means of a pivot movement about the virtual longitudinal axis. This occurs, in particular, in toe-in steering or when the wheel goes into negative camber.

A preferred variant of an embodiment of such a toe-correcting mechanism is known from the German patent DE 10 2011 013 265 A1, the content of the disclosure and the figures of which are hereby incorporated by reference in their entirety.

Therefore, such a toe correcting mechanism is characterized preferably as described by the following.

The inventive axle of the motor vehicle is a torsion beam axle, which is formed by a torsion profile with longitudinal rocker arms connected thereto. In this case a wheel suspension is coupled to the free ends of the longitudinal rocker arms by means of at least one elastic bearing, so that the wheel suspension is coupled in such a way that it can be pivoted about a virtual steering axis. According to the invention, the axle of the motor vehicle is characterized by the feature that the wheel suspension is coupled to the longitudinal rocker arm by means of a pivot bearing having at least one degree of rotational freedom and by means of two rubber-to-metal bearings, where, in this case, the degree of rotational freedom rotates about the virtual steering axis.

Within the context of the invention, the pivot bearing has exclusive degrees of rotational freedom, but only the degree of rotational freedom about the steering axis is absolutely mandatory. In order to implement this function, it would be conceivable to use, for example, a spherical plain bearing, a ball joint, a rubber bearing or, instead, any other bearing with at least one degree of rotational freedom. The result is a real pivot point, about which the wheel suspension and a wheel that is coupled to the wheel suspension can be pivoted by adjusting the toe and/or camber.

The two rubber-to-metal bearings are arranged in such a way that they form a spring balance point that lies, based on the coordinate system of the motor vehicle, outside the motor vehicle. The spring balance point and the pivot bearing define the steering axis.

For this purpose, the rubber-to-metal bearings have preferably a longitudinal axis, with the elongation of the longitudinal axis forming roughly the spring balance point that has already been mentioned above. Therefore, between the pivot bearing and the spring balance point, the steering axis is formed; it is particularly preferred that this steering axis, in turn, intersect the wheel centre point. This arrangement offers the option of achieving a passively actuated virtual steering axis at an axle of the motor vehicle, in particular, at a torsion beam rear axle. The arrangement according to the invention is distinguished by its simple construction, good reproducibility and its being maintenance-free in normal operating mode. Furthermore, the inventive axle of the motor vehicle is distinguished by the feature that, when the payload of, for example, the boot, is increased or when driving over bumps on the road, thus, during parallel compression of both wheels that are mounted on the axle, there is no relative toe correction between the wheel suspension and the longitudinal rocker arm.

According to the invention, the actual compression (jounce) and extension (rebound) behavior, thus, the suspension kinematics of the torsion beam axle, are retained. In this case, a toe correction, in particular, the relative toe correction between the wheel suspension and the longitudinal rocker arm, which is possible as a result of the inventive coupling of the wheel suspension at the longitudinal rocker arm, is carried out almost exclusively by means of the application of the braking force. For example, the application of the force Fx in the X direction of the motor vehicle or by means of the application of the lateral force Fy when cornering.

In the event that the braking force is applied, a toe-in correction takes place, where, in this case, a standard braking maneuver when driving straight ahead induces a toe-in correction at both motor vehicle wheels of an axle. When driving through a curve, a toe-in correction takes place at the wheel that is located on the outside when cornering; and optionally a toe-out correction takes place at the wheel that is located on the inside when cornering. These toe corrections largely take place as a result of the relative displacement between the wheel suspension and the longitudinal rocker arm. In general, the respective coupling kinematics of the torsion beam axle is also carried out at the same time during the respective maneuver.

In an additional preferred variant of the embodiment of the present invention, the pivot bearing is arranged, based on the coordinate system of the motor vehicle, above the rubber-to-metal bearings, preferably above the centre point of the wheel. This arrangement meets the objective of ensuring that the virtual steering axis runs in such a way that it oriented in the Z direction and the Y direction of the motor vehicle analogous to a negative camber and has preferably a negative castor in the Z and X direction of the motor vehicle. Furthermore, the virtual steering axis is positioned preferably in such a way that a negative castor offset is present at the respective wheel. Similarly, it is advantageous in accordance with the invention that the virtual steering axis is positioned in such a way that a negative kingpin radius is present at the respective wheel.

Preferably the pivot bearing is designed as a ball joint. A ball joint has three degrees of rotational freedom, where, in this case, the degree of rotational freedom is used largely or, instead, exclusively about the virtual steering axis. For the bottom rubber-to-metal bearings, bearings having an axial rigidity that is high in relation thereto and having a radial rigidity that is low in relation thereto are used. However, owing to the wear of the rubber-to-metal bearings due to use over the duration of the use of the motor vehicle, a ball joint also offers two additional degrees of rotational freedom, so that it is possible to compensate here for tolerances or, more specifically, vibrations without having to avoid a deflection or the like with respect to a bearing having only one degree of rotational freedom. As a result, the system is wear resistant and usually maintenance-free over the service life of the motor vehicle.

Preferably a ratio of radial rigidity to axial rigidity is selected in such a way that it is in a range of 1:30 to 1:50. In this case, a low radial rigidity can be seen in a ratio to an axial rigidity that is thirty to fifty times as high. In particular, the rigidity ratio can also be formed in a range between 1:35 to 1:45 or, in particular, in a ratio of the radial rigidity to the axial rigidity of 1:40.

In this context, the axial rigidity increases progressively in accordance with the invention, especially when the force effect is higher. In addition, the radial rigidity runs almost linearly with only a slight increase. Especially when the rubber-to-metal bearings are installed in the prestressed state, it is possible to increase the radial to axial ratio. This arrangement ensures that the two rubber-to-metal bearings form, as an elastic system, a spring balance point, so that a low torsional rigidity of the replacement system allows the spring balance point to be construed as the pivot point of the elastic system. In this case, the position of the spring balance point depends on the orientation of the elastic components as well as the radial to axial rigidity ratio of the elastic components.

Preferably the two rubber-to-metal bearings are arranged, based on the coordinate system of the motor vehicle, below the pivot bearing and, in particular, preferably below the wheel centre. The reference “below the wheel centre” means, in turn, with respect to the coordinate system of the motor vehicle, not that it lies vertically, i.e., in the Z direction directly underneath the wheel centre, but rather that it can also be arranged vertically below and horizontally offset thereto. Furthermore, the rubber-to-metal bearing, which is located in the rear in the main direction of travel, is oriented preferably with its longitudinal axis more or less parallel to the wheel's axis of rotation.

The rubber-to-metal bearing that is located in the front in the direction of travel is arranged preferably with its longitudinal axis at an angle a to the wheel's axis of rotation, where, in this case, the angle is preferably in a range of 10° to 40°, in particular, 20° to 35°; and an angle of 30° is preferred.

In an additional preferred variant of the embodiment, a plane is formed between the pivot bearing, the front rubber-to-metal bearing and the spring balance point or, instead, between the pivot bearing, the rear rubber-to-metal bearing and the spring balance point. In this case, the radial direction of the respective rubber-to-metal bearing is normal relative to the plane formed in each case.

In another preferred variant of the embodiment of the present invention, the wheel suspension is a single shell sheet metal component. The term “wheel suspension” is understood to mean, in the context of the invention, a suspension component that is connected to the longitudinal rocker arm by means of the inventive coupling. The wheel suspension itself may accommodate in turn a wheel carrier or, instead, may have directly a wheel bearing with an appropriate wheel hub for purposes of connecting to a wheel. The sheet metal component is preferably a formed component, in particular, designed as a thermoformed and press-hardened component. However, it can also be a forging or a casting. It is particularly preferred that the wheel suspension itself exhibit in turn a flange region, which can be produced with suitable precision, for example, by means of a subsequent re-machining operation.

It is particularly preferred that the rubber-to-metal bearings be made of two rubber-to-metal disc assemblies, where, in this case, each of the rubber-to-metal disc assemblies is arranged on one side of the wheel suspension and where a screw bolt extends through the rubber-to-metal disc assemblies and the wheel suspension in a positive locking manner. As a result of the respective arrangement of the rubber-to-metal discs in a composite, it is possible to set a high axial rigidity in relation to a low radial rigidity, with both being optimally necessary for the inventive operating behavior of the toe correction.

Within the scope of the invention, the rubber-to-metal bearings should be designed with a Shore hardness between 65 and 75. The rigidity ratio should be in the range between 10 kN/mm and 20 kN/mm, in particular, at approximately 15 kN/mm. The axial rigidity should be selected in relation to the radial rigidity in such a way that the axial rigidity is preferably 40 times greater.

In an additional preferred variant of the embodiment, a rubber-to-metal disc assembly is constructed of three metal discs, where, in this case, a rubber layer is inserted between the metal discs. In this case, the rubber layer can be, for example, vulcanized on or the rubber discs can also be arranged in a composite with the metal discs. These metal discs can also be preferably glued to each other.

In another preferred variant of the embodiment, the rubber-to-metal disc assemblies are prestressed. In this case, the rubber layer is designed to project at least in regions beyond the metal disc. This arrangement makes it possible, in particular, to set a high axial rigidity at a low radial rigidity.

In an additional preferred variant of the embodiment, a wheel carrier can be screwed to the wheel suspension, with the wheel carrier being preferably adjustable relative to the wheel suspension. That being the case, it is possible to adjust the production tolerances of the torsion beam axle, the wheel suspension or, instead, the suspension by pre-adjusting the toe and camber of the wheel carrier in relation to the wheel suspension. During the operating performance itself, the wheel suspension and the wheel carrier are designed as a rigid unit. In another preferred variant of the embodiment, the wheel suspension can be adjusted relative to the longitudinal rocker arm, preferably by means of an eccentric offset of the ball joint. At the same time, it is possible to make a toe and/or camber correction by means of the elastically mounted wheel suspension. Furthermore, the toe correction occurring during the operating performance can be set in its intensity, based on the compression travel or rebound travel, in such a way that the result is not a relative toe correction value, but rather this value follows almost exclusively from the suspension kinematics of the torsion beam axle.

Therefore, it is possible to use, for example, a rear axle structure in the construction of a utility vehicle, where, in this case, the various superstructures of the utility vehicle may cause mass variances in the curb weight of the motor vehicle of up to 1,000 kg. Correspondingly a toe correction adjustment has to be made individually for each variant of the superstructure.

### DESCRIPTION OF THE DRAWINGS

Other advantages, features, properties and aspects of the present invention are shown in the schematic figures, which are intended to facilitate a better understanding of the invention. The drawings show in:

FIG. 1 consists of FIGS. 1A and 1B in each case a longitudinal cross sectional view of the solid rubber bearing;

FIG. 2 an alternative variant of the embodiment from FIG. 1;

FIG. 3 consists of FIGS. 3A, 3B and 3C various plan views of a spacer; and

FIG. 4 a longitudinal cross sectional view of a bearing of an alternative embodiment.

### DETAILED DESCRIPTION OF THE INVENTION

In the figures the same reference numerals are used for identical and similar components, even if there is no repetition of the description for the sake of simplification.

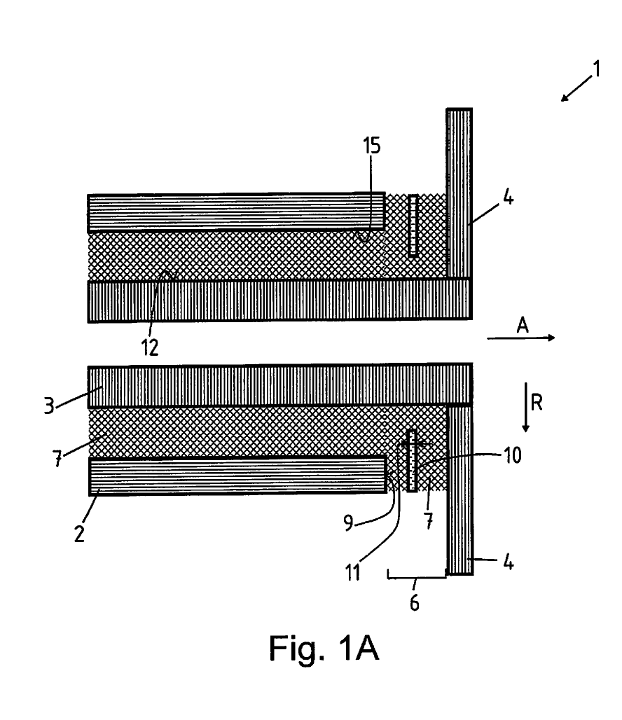

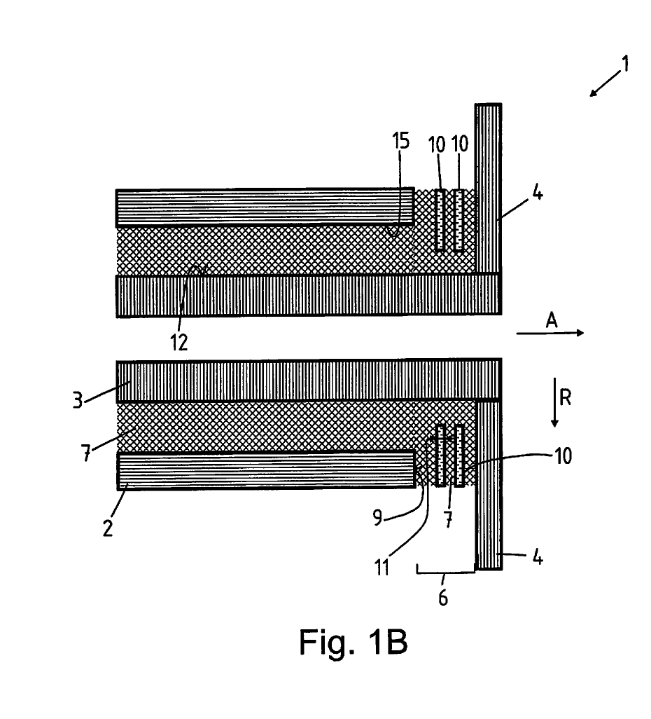

FIG. 1A shows a longitudinal cross sectional view of a solid rubber bearing 1 of the invention. The inner sleeve 3, the outer sleeve 2 as well as the stop disc 4 and an elastic intermediate layer 7, also called the rubber layer, can be seen in this drawing. At this point the invention provides that between the end 9 of the outer sleeve 2 and the stop disc 4 a space 6 is formed. In this space 6 a spacer 10 is arranged, where, in this case, the spacer 10 is made of a solid material, in particular, a synthetic plastic material or metal. The thickness 11 of the spacer 10 reduces the existing elastic volume in the region of the space 6, an aspect that greatly impedes the rubber layer from expanding in the transverse direction and that results in a higher axial rigidity. The interspace between the outer sleeve 2 and the inner sleeve 3, which is filled with the elastic intermediate layer 7, remains almost unchanged, for which reason the radial rigidity, thus, the rigidity in the radial direction R remains approximately constant or increases only insignificantly in comparison to the axial rigidity. Therefore, such an inventive solid rubber bearing 1 has an axial rigidity that is higher than the radial rigidity, in particular, in a ratio greater than 1.5:1, in particular, greater than 2:1, preferably greater than or equal to 2.5:1. The intermediate layer 7 projects beyond the inner shell surface 15 of the inner sleeve 3 in the radial direction R in the region of the space 6.

FIG. 1B shows a variant of the embodiment analogous to FIG. 1A. In this case, two spacers 10 are arranged parallel at a distance from each other in the axial direction A. As an alternative, the thickness 11 of the spacer 10 can also vary as a function of the desired axial rigidity.

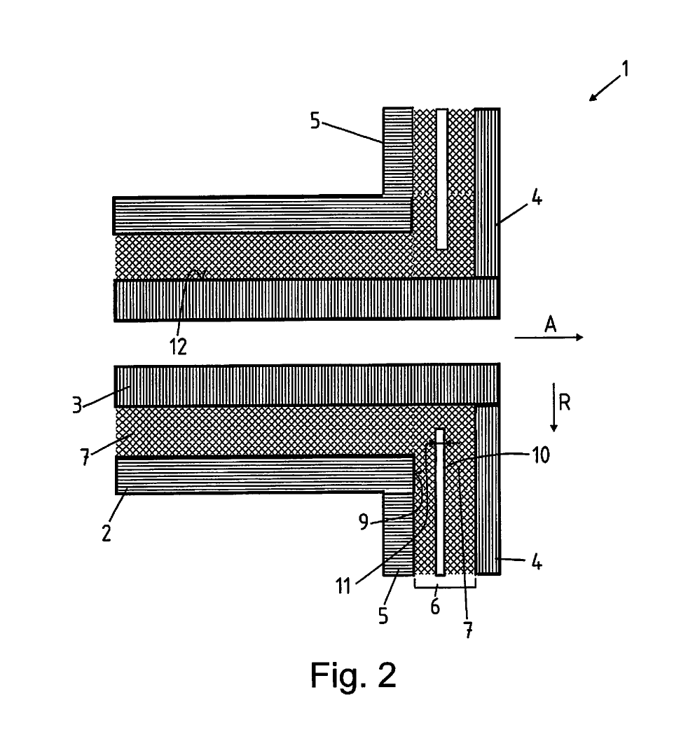

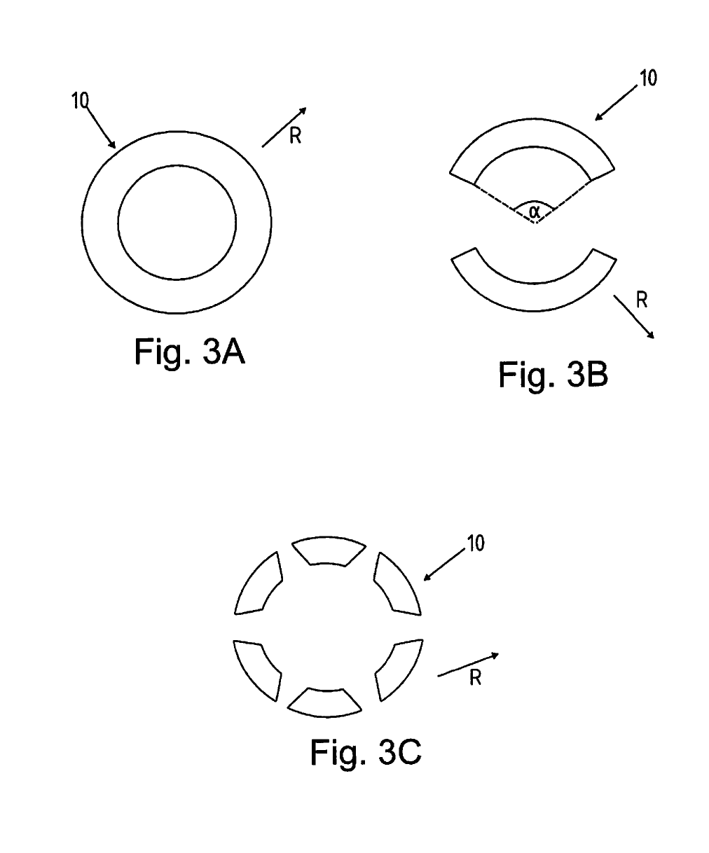

FIG. 2 shows a variant of the embodiment analogous to FIGS. 1A and 1B. However, in this case, the collar 5 from FIG. 1 is drawn in the region of the end 9 of the outer sleeve 2. As a result, the surfaces of the collar 5 and the stop disc 4 are opposite each other with the incorporation of the spacer 10 and the intermediate layer 7 and increase the surface area on which a force that is to be transmitted is distributed in the axial direction A. Similarly, it is shown in FIGS. 2 and 3 that, based on the radial direction R, the spacer 10 and the outer shell surface 12 of the inner sleeve 3 are spaced apart from each other; and that here, too, the intermediate layer 7 is arranged in such a way that it extends to either side of the spacer 10. At the same time, the spacer 10 can be totally enclosed by the intermediate layer 7 or, instead, can also terminate, based on the radial direction R, outwards with the intermediate layer 7 and/or can be designed to project beyond the intermediate layer 7.

FIGS. 3A, 3B and 3C show various variants of the embodiment of the spacers 10 in a plan view. According to FIG. 3A, the spacer 10 is designed as a disc, according to the principle of a washer. According to FIG. 3B, the spacer 10 is designed in two pieces in a radially circumferential manner, where, in this case, each piece of the spacer 10 extends in a radially circumferential manner over an angular region a. According to FIG. 3C, the spacer 10 is constructed of six partial pieces extending circumferentially in multiple sections in the radial direction. In the area, in which there is no spacer 10, the intermediate layer 7 would be formed.

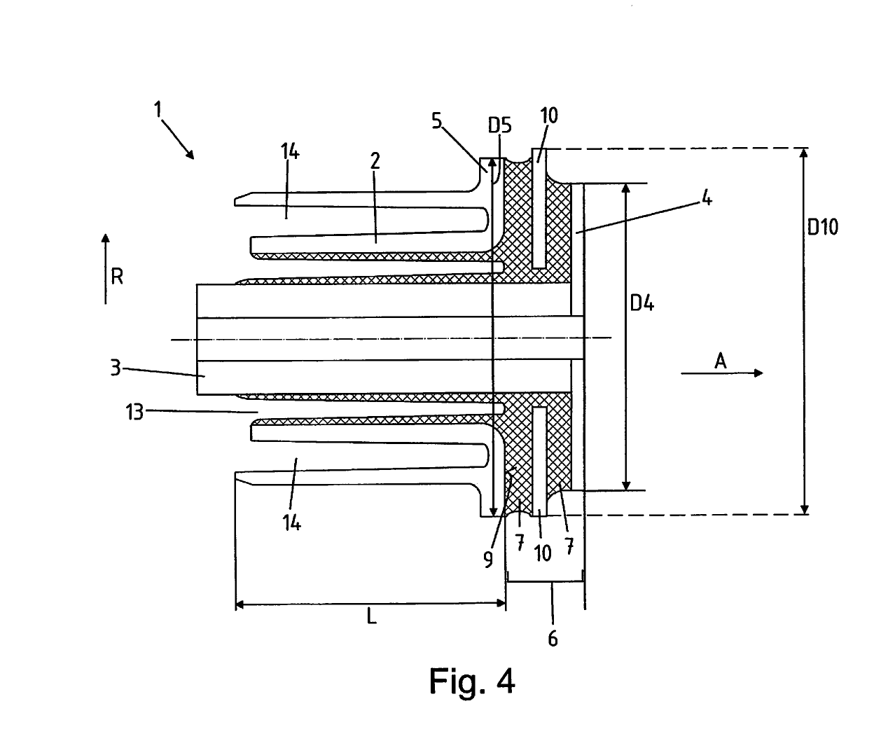

FIG. 4 shows an alternative variant of the embodiment of the solid rubber bearing 1 of the invention in a longitudinal cross-sectional view. This view shows in turn an inner sleeve 3 and an outer sleeve 2, with the inner sleeve 3 having a stop disc 4 on an axial end. Similarly, the outer sleeve 2 extends only over a portion of the inner sleeve 3 in the axial direction A. Therefore, a space 6 is produced between the end 9 of the outer sleeve 2 and the stop disc 4. A spacer 10 is arranged in the space 6. As an alternative to FIG. 2, however, the elastic intermediate layer 7 between the outer sleeve 2 and the inner sleeve 3 has now a cavity 13, so that the conditions for a progressivity of the intermediate layer 7, based on the radial rigidity, are met. At the same time, the cavity 13 extends radially at least partially circumferentially, preferably completely circumferentially and in the axial direction A at least partially, preferably, as shown, over a large portion of the axial length L of the outer sleeve 2. It is also possible to introduce hollow channels that are also distributed circumferentially. Furthermore, the outer sleeve 2 also has preferably a cavity 14, where, in this case, the cavity is also formed preferably at least partially circumferentially in the axial direction A. This aspect leads to a weight reduction of the outer sleeve 2. In this case, too, the radius of the outer sleeve 2 is also designed to be larger than the radius of the stop disc 4. Furthermore, in this variant of the embodiment, the spacer 10 has preferably a diameter D10 that is larger than a diameter D5 of the collar 5, where, in this case, the diameter D5 in turn is larger than a diameter D4 of the stop disc 4. The elastic intermediate layer 7 is arranged between the collar 5 and the end 9 of the outer sleeve and the spacer 10 and also between the spacer 10 and the stop disc 4. Similarly, the elastic intermediate layer 7 is arranged in such a way that it extends through the spacer 10.

### LIST OF REFERENCE NUMERALS AND SYMBOLS

1—solid rubber bearing

2—outer sleeve

3—inner sleeve

4—stop disc

5—collar

6—space

7—intermediate layer

9—end with respect to 2

10—spacer

11—thickness with respect to 10

12—outer shell surface with respect to 3

13—cavity with respect to 7

14—cavity with respect to 2

15—inner shell surface with respect to 3

A—axial direction

D4—diameter with respect to 4

D5—diameter with respect to 5

D 10—diameter with respect to 10

L—length with respect to 2

R—radial direction

1. Solid rubber bearing for arranging on an axle of a motor vehicle, the solid rubber bearing comprising an inner sleeve and an outer sleeve, with an elastic intermediate layer being arranged between the inner sleeve and the outer sleeve;
on one side the inner has a stop disc that extends radially outwards from the inner sleeve, with the outer sleeve extending in the axial direction over a portion of the inner sleeve; and
with a space being formed between the outer sleeve and the stop disc, wherein at least one spacer made of a solid material is arranged in the region of the space.

2. The solid rubber bearing, as claimed in claim 1, wherein the elastic intermediate layer is arranged in the space and preferably the elastic intermediate layer in the space projects beyond at least the inner shell surface of the inner sleeve in the radial direction.

3. The solid rubber bearing as claimed in claim 1, wherein the spacer is designed in a radially circumferential manner as a disc; or that the spacer is constructed in multiple pieces distributed circumferentially in the radial direction.

4. The solid rubber bearing, as claimed in claim 1, wherein two or more spacers are located parallel at a distance from each other in the axial direction.

5. The solid rubber bearing, as claimed in claim 1, wherein an outer shell surface of the inner sleeve and the spacer are radially spaced apart from each other, and the intermediate layer is arranged so as to extend through the spacer.

6. The solid rubber bearing, as claimed in claim 1, wherein the intermediate layer is made of a rubber-like material and/or elastomeric material and is glued to the outer sleeve and/or the inner sleeve and/or the stop disc.

7. The solid rubber bearing, as claimed in claim 1, wherein the outer sleeve has a collar, which is outwardly oriented in the radial direction, on its end facing the stop disc.

8. The solid rubber bearing, as claimed in claim 1, wherein the spacer is made of a metallic material or a synthetic plastic material.

9. The solid rubber bearing, as claimed in claim 1, wherein the stop disc is made in one piece and in a materially uniform manner with the inner sleeve or that the stop disc is coupled to the inner sleeve as a separate component.

10. The solid rubber bearing, as claimed in claim 1, wherein a cavity, which extends at least in sections in the axial direction and which extends at least partially circumferentially in the radial direction, is formed in the intermediate layer between the inner sleeve and the outer sleeve.

11. The solid rubber bearing, as claimed in claim 1, wherein a cavity, which extends at least in sections in the axial direction and which extends at least partially circumferentially in the radial direction, is formed in the outer sleeve.

12. The solid rubber bearing, as claimed in claim 1, wherein the ratio of the axial rigidity to the radial rigidity is greater than 1.5 to 1, in particular, greater than 2 to 1 and preferably greater than or equal to 2.5 to 1.
